(19) United States
(12) Patent Application Publication
(10) Pub. No.: US 2009/0122539 A1
(43) Pub. Date: May 14, 2009

(54) Light-emitting decorating device

(76) Inventor: Chi-Shih Lai, Panchiao (TW)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/979,795

(22) Filed: Nov. 8, 2007

(51) Int. Cl. F21V 33/00; F21S 13/14; F21K 7/00

(52) U.S. Cl. 362/235; 362/311.13; 362/311.02

(57) ABSTRACT

A light-emitting decorating device includes a framework, a light-transmitting cover and at least one light source. The framework is a hollow construction and comprises a plurality of supporting brackets and a plurality of decorating brackets provided between the supporting brackets. The light-transmitting cover is provided inside the framework, thereby the framework and the light-transmitting cover together constituting the profile of the light-transmitting decorating device. The light source is provided in the interior of the light-transmitting cover. Via the above arrangement, a light-emitting decorating device can be achieved, thereby generating a better visual effect and adding a novel and shining effect to the whole profile.

### BACKGROUND OF THE INVENTION

1. Field of the Invention

The present invention is related to a light-emitting decorating device, and more particular to a light-emitting decorating device that has a three-dimensional profile and can emit light variably via an associated light source to generate a better visual effect.

2. Description of Related Art

On important festivals and celebrations, people will decorate their houses to symbolize the festival, thereby generating a festival atmosphere. Further, the decorations can be made of light-transmitting materials, and light sources are disposed in the interior of the decorations. With the light sources emitting the light, a light-emitting decorating device can be achieved, thereby generating a better decorating effect. In the above-mentioned light-emitting decorating device, the light sources are simply disposed in the interior of the decorating device. Therefore, when the light of the light source pierces the decorating device so as to emit outwardly, the visual effect generated is limited. As a result, it is difficult to generate a better visual effect.

For example, Taiwan Patent publication No. M262373 published on Apr. 21, 2005 discloses an improved structure of a light-emitting decoration, in which light-emitting elements are provided in a base and the interior of a light-transmitting portion to emit the light, the light pierces the base and the light-transmitting portion to emit outwardly. However, the visual effect generated is still so limited that it is difficult to generate a better visual effect.

Consequently, because of the above technical defects, the inventor keeps on carving unflaggingly through wholehearted experience and research to develop the present invention, which can effectively improve the defects described above.

### SUMMARY OF THE INVENTION

The object of the present invention is to provide a light-emitting decorating device that is capable of generating a better visual effect so as to add a novel and shining effect to the whole profile.

For achieving the object described above, the present invention provides a light-emitting decorating device, which includes: a hollow framework, the framework comprising a plurality of supporting brackets and a plurality of decorating brackets provided between the supporting brackets; a light-transmitting cover provided inside the framework, the framework and the light-transmitting cover together constituting the profile of the light-emitting decorating device; and at least one light source provided in the interior of the light-transmitting cover.

The present invention has advantageous effects as follows. The light source of the present invention can emit light to pierce the light-transmitting cover and the framework so as to emit outwardly. Since the light-emitting decorating device has a three-dimensional profile, the material property of the light-transmitting cover and the variable profile of the framework exhibited outside the light-transmitting cover together with the variable light of the light source can generate a better visual effect so as to add a novel and shining effect to the whole profile.

In order to further understand the characteristics and technical contents of the present invention, a detailed description is made with reference to the accompanying drawings. However, it should be understood that the drawings are illustrative only but not used to limit the present invention thereto.

### BRIEF DESCRIPTION OF THE DRAWINGS

FIG. 1 is a perspective view showing the light-emitting decorating device of the present invention;

FIG. 2 is a cross-sectional view showing the light-emitting decorating device of the present invention;

FIG. 3 is a perspective view showing an operating state of the light-emitting decorating device of the present invention; and

FIG. 4 is a perspective view showing an operating state of the light-emitting decorating device in accordance with another embodiment of the present invention.

### DETAILED DESCRIPTION OF THE PREFERRED EMBODIMENTS

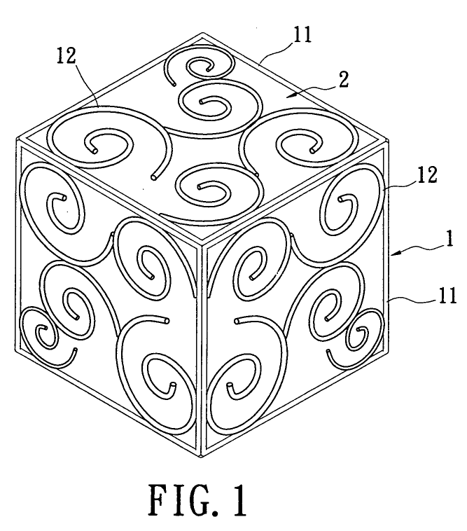

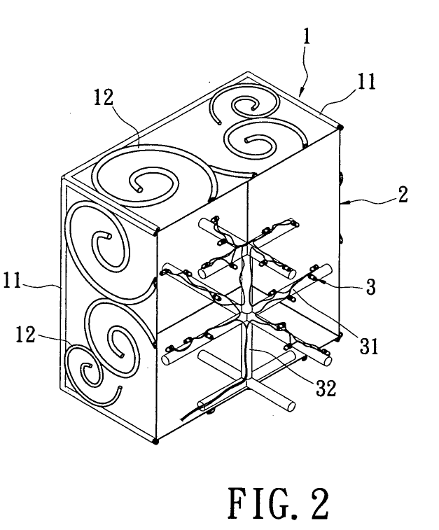

Please refer to FIGS. 1 to 3. The present invention is to provide a light-emitting decorating device, the shape of which is not limited to particular ones but can be formed into various animals, plants, cartoon figures, geometric shapes or other arbitrary shapes. In the present embodiment, the light-emitting decorating device is a cubic body which includes a framework 1, a light-transmitting cover 2 and at least one light source 3. The shape and construction of the framework 1 are not limited to particular forms and can be substantially formed into a profile corresponding to that of the light-emitting decorating device. In the present embodiment, the light-emitting decorating device is a cubic body, so that the framework 1 has a corresponding hollow cubic construction. The framework 1 is made of metallic or plastic materials. The framework 1 comprises a plurality of supporting brackets 11 that are connected to form a cubic construction. A plurality of decorating brackets 12 is provided between the supporting brackets 11. The decorating brackets 12 may have a shape of various patterns or characters. In the present embodiment, the decorating bracket 12 is a volute line.

The light-transmitting cover 2 is made of a plastic piece, cloth or paper that has a light-transmitting property. The light-transmitting cover 2 can be made of three-dimensional cloth. The color of the light-transmitting cover 2 can be varied according to practical demands, and patterns or characters can be printed on the light-transmitting cover 2. The light-transmitting cover 2 is fixedly provided in the inside or outside of the framework 1. In the present embodiment, the light-transmitting cover 2 is provided in the inside of the framework 1, so that the framework 1 and the light-transmitting cover 2 together constitute the profile of the light-emitting decorating device. The framework 1 is exposed to the outside (inside) of the light-transmitting cover 2, thereby displaying a three-dimensional aesthetic feeling of the framework 1.

The light source 3 can be various light-emitting elements such as light-emitting diodes (LED), bulbs, lamp tubes or Christmas lamps. The number and locations of the light sources 3 are not limited and can be varied according to practical demands. The shining state and the colors of the light sources 3 can be also suitably controlled to generate a better decorating effect. The light source 3 is electrically connected to a power supply line 3. When the power supply line 31 supplies the power necessary for the light source 3, the light source 3 can emit the light immediately. In the present embodiment, there is a plurality of light sources 3. These light sources are suitably supported and fixed within the framework 1 via supports 32. Via the above construction, the light-emitting decorating device of the present invention can be achieved.

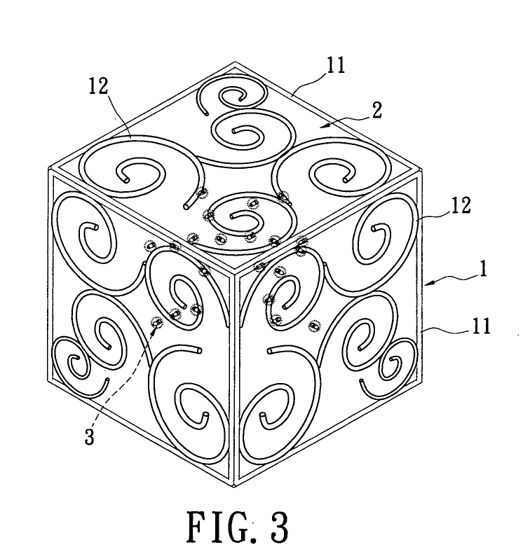

When the power supply line 31 supplies the power necessary for the light source 3, the light source 3 can emit the light immediately. The emitted light pierces the light-transmitting cover 2 and the framework 1 to emit outwardly (FIG. 3). Since the light-emitting decorating device of the present invention has a three-dimensional profile, the material property of the light-transmitting cover 2 and the variable profile of the framework 1 exhibited outside (inside) the light-transmitting cover 2 together with the variable light of the light source 3 can generate a better visual effect so as to add a novel and shining effect to the whole profile.

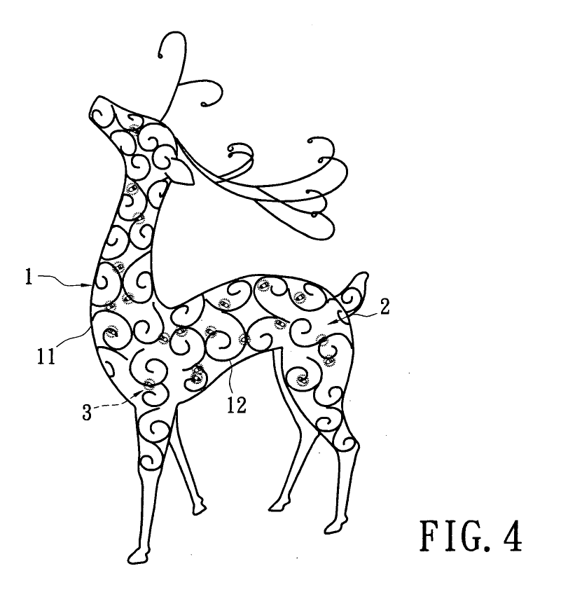

Please refer to FIG. 4. In the present embodiment, the light-emitting decorating device has a deer shape. Therefore, the framework 1 is a construction having a corresponding deer shape. The framework 1 comprises a plurality of supporting brackets 11. The supporting brackets 11 are connected to form a desired profile. The decorating brackets 12 are formed into volute lines and are disposed between the supporting brackets 11. The light-transmitting cover 2 is provided in the inside or outside of the framework 1, thereby the framework 1 and the light-transmitting cover 2 together constituting the profile of the light-emitting decorating device. The light source 3 is provided in the inside of the light-transmitting cover 2. Since the usage and function of the present embodiment are substantially identical to those of the previous embodiment, the description thereof is omitted for simplicity.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A light-emitting decorating device, comprising:
a hollow framework comprising:
a plurality of supporting brackets and a plurality of decorating brackets provided between the supporting brackets;
a light-transmitting cover formed on one of an inside and an outside of the framework, the plurality of decorating brackets being distributed on a surface of the light-transmitting cover, and the framework and the light-transmitting cover together constituting a profile of the light-emitting decorating device; and
at least one light source provided inside the light-transmitting cover.

2. The light-emitting decorating device according to claim 13 wherein the decorating brackets have a shape of predetermined patterns or characters.

3. The light-emitting decorating device according to claim 13, wherein the light-transmitting cover comprises one of a plastic piece, cloth and a paper piece.

4. The light-emitting decorating device according to claim 16, wherein the light source comprises one of a light-emitting diode, bulb, lamp tube and Christmas lamp.

5. The light-emitting decorating device according to claim 4, wherein the light source is electrically connected with a power supply line to supply electricity for the light source.

6-12. (canceled)

13. The light-emitting decorating device according to claim 1, wherein said profile comprises a three-dimensional profile including one of an animal shape, plant shape, cartoon figure shape, geometric shape and an arbitrary shape.

14. The light-emitting decorating device according to claim 13, wherein said framework comprises one of a metal framework and a plastic framework, and wherein said light-emitting cover comprises one of a printed pattern and a printed character.

15. The light-emitting decorating device according to claim 2, wherein said plurality of decorating brackets comprise a plurality of volute line shapes which contact each other and contact said plurality of supporting brackets.

16. The light-emitting decorating device according to claim 1, wherein the light source is fixed on said plurality of decorating brackets.

17. The light-emitting decorating device according to claim 5, further comprising:
a support formed inside said framework and having a three-dimensional shape, for supporting said light source.

18. The light-emitting decorating device according to claim 17, wherein said light source comprises plural light-emitting diodes (LEDs) connected by power supply lines, said plural LEDs and power supply lines being fixed on said three dimensional shape of said support.
